(19) United States
(12) Patent Application Publication
(10) Pub. No.: US 2025/0076551 A1
(43) Pub. Date: Mar. 6, 2025

(54) WAVEGUIDE INCLUDING AN OPTICAL GRATING WITH REDUCED CONTAMINATION AND METHODS OF PRODUCTION THEREOF

(71) Applicant: GOOGLE LLC, Mountain View, CA (US)

(72) Inventors: Joseph Daniel Lowney, Tucson, AZ (US); Wei Jin, Saratoga, CA (US)

(21) Appl. No.: 18/728,520

(22) PCT Filed: Dec. 6, 2022
(86) PCT No.: PCT/US2022/051898

§ 371 Date: Jul. 12, 2024

Related U.S. Application Data
(60) Provisional application No. 63/299,132, filed on Jan. 13, 2022.

(51) Int. Cl. G02B 5/18; G02B 6/12; G02B 6/34; G02B 27/01

(52) U.S. Cl. CPC G02B 5/1857; G02B 6/12; G02B 6/34; G02B 27/0172; G02B 2006/12038; G02B 2006/12107; G02B 2006/12173; G02B 2006/12176

(57) ABSTRACT

The present disclosure provides techniques to reduce or eliminate contaminants in a waveguide resulting from the waveguide fabrication process. A blocking layer is deposited on a grating layer to protect the grating layer from contamination, e.g., via diffusion, from a hardmask layer that is used to pattern the grating layer. Accordingly, the optical gratings resulting from the patterning of the grating layer have little or no contamination from the hardmask layer, thereby increasing the optical performance of the final waveguide product.

### CROSS-REFERENCE TO RELATED APPLICATIONS

The present application claims priority to U.S. patent application Ser. No. 63/299,132 entitled “Optical Element Resistant to Contamination,” and filed on Jan. 13, 2022, the entirety of which is incorporated by reference herein.

### BACKGROUND

In the field of optics, an optical combiner is an optical apparatus that combines two light sources such as environmental light from outside of the optical combiner and light emitted from a micro-display that is directed to the optical combiner via a waveguide. Optical combiners are used in wearable heads up displays (WHUDs), sometimes referred to as head-mounted displays (HMDs) or near-eye displays, which allow a user to view computer-generated content (e.g., text, images, or video content) superimposed over a user's environment viewed through the HMD, creating what is known as augmented reality (AR) or mixed reality (MR).

In a conventional HMD, light beams from an image source or a projector are coupled into a light guide substrate, generally referred to as the waveguide, by an input optical coupling (referred to as an “incoupler”) such as an optical grating, which can be formed on a surface, or multiple surfaces, of the substrate or disposed within the substrate. Once the light beams have been coupled into the waveguide, the light beams are “guided” through the waveguide, typically by multiple instances of total internal reflection (TIR), to then be directed out of the waveguide by an output optical coupling (referred to as an “outcoupler”), which can also take the form of an optical grating. The light beams ejected from the waveguide overlap at an eye relief distance from the waveguide forming an exit pupil within which a virtual image generated by the image source can be viewed by the user of the HMD.

### SUMMARY

In accordance with one aspect, a method for producing a waveguide with one or more optical gratings is provided. The method includes forming a blocking layer between a grating layer and a hardmask layer, the grating layer located on a surface of a substrate layer corresponding to a substrate of the waveguide. The method further includes etching the hardmask layer in a first etching step to form a plurality of hardmask layer segments with a plurality of gaps therebetween exposing a surface of the blocking layer. The method further includes etching through the exposed surface of the blocking layer toward the surface of the substrate layer in a subsequent etching step to form a plurality of caps in the blocking layer between the plurality of hardmask layer segments and a plurality of ridges in the grating layer. The method further includes removing the plurality of hardmask layer segments, wherein the plurality of ridges in the grating layer corresponds to the one or more optical gratings.

In some aspects, the method includes removing the plurality of caps in the blocking layer to leave the plurality of ridges in the grating layer on the substrate layer. In some aspects, the blocking layer includes SiO₂ or SiN, the grating layer includes TiO₂, and the hardmask layer includes chromium (Cr). In some aspects, the method includes forming a softmask layer on the hardmask layer and patterning the softmask layer to form a pattern used to etch the hardmask layer in the first etching step. In some aspects, the method includes patterning the softmask layer via nano imprint lithography (NIL). In some aspects, the method includes removing the softmask layer after the first etching step. In some implementations, the softmask layer includes or is based on a sol-gel material. In some aspects, the method includes that the subsequent etching step includes using a common etching reagent to etch through the blocking layer and the grating layer. The method can also include that the subsequent etching step includes etching through the blocking layer and the grating layer to the surface of the substrate layer. In some aspects, the plurality of ridges in the grating layer are substantially free of contamination from the hardmask layer. In some aspects, the one or more optical gratings formed by the method correspond to at least one of an incoupler grating or an outcoupler grating in a waveguide.

In accordance with another aspect, a method of producing a waveguide with one or more optical gratings is provided. The method includes forming a blocking layer between a grating layer and a hardmask layer, the grating layer located on a surface of a substrate layer corresponding to a substrate of the waveguide. The method further includes etching the hardmask layer in a hardmask etching step to form a plurality of hardmask layer segments with a plurality of gaps therebetween exposing a surface of the blocking layer. Then, the method includes etching through the exposed surface of the blocking layer toward the surface of the substrate layer in a subsequent etching step to form a plurality of caps in the blocking layer between the plurality of hardmask layer segments and a plurality of ridges in the grating layer, where the blocking layer reduces diffusion from the hardmask layer into the grating layer.

In some aspects, the method includes removing the plurality of hardmask layer segments via a wet etch removal to leave the plurality of caps in the blocking layer over the plurality of ridges in the grating layer on the substrate layer, where the plurality of ridges in the grating layer is substantially free from contaminants resulting from the hardmask layer. In some aspects of the method, the blocking layer includes SiO₂ or SiN and the hardmask layer includes Cr. In some aspects of the method, the plurality of ridges in the grating layer corresponds to the one or more optical gratings, wherein the one or more optical gratings are at least one of an incoupler or an outcoupler

In accordance with another aspect, a waveguide is provided. The waveguide includes one or more optical gratings including a first, high-refractive index material, each of the one or more optical gratings including a plurality of ridges. The waveguide also includes a plurality of caps covering the plurality of ridges, where the plurality of caps includes a second material different from the first, high-refractive index material, and where the plurality of caps shields the plurality of ridges from contamination attributed to a hardmask layer during the fabrication of the waveguide.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 shows an example display system having a support structure that houses a projection system configured to project images toward the eye of a user, in accordance with some embodiments.

FIG. 2 shows an example of a block diagram of a projection system that projects light representing images onto the eye of a user via a display system, such as the display system of FIG. 1, in accordance with some embodiments.

FIG. 3 shows a flowchart of a method for assembling a waveguide fabrication stack to use in the manufacturing of a waveguide, in accordance with some embodiments.

FIG. 4 shows diagrams illustrating the formation of the waveguide fabrication stack according to the method described in FIG. 3, in accordance with some embodiments.

FIG. 5 shows a flowchart of a method for forming a waveguide, from the waveguide fabrication stack described in FIGS. 3-4, with optical gratings having reduced contamination to use in a projection system such as the one shown in FIG. 2, in accordance with some embodiments.

FIGS. 6-7 show diagrams illustrating the formation of a waveguide with optical gratings having reduced contamination according to the method described in FIG. 5, in accordance with some embodiments.

### DETAILED DESCRIPTION

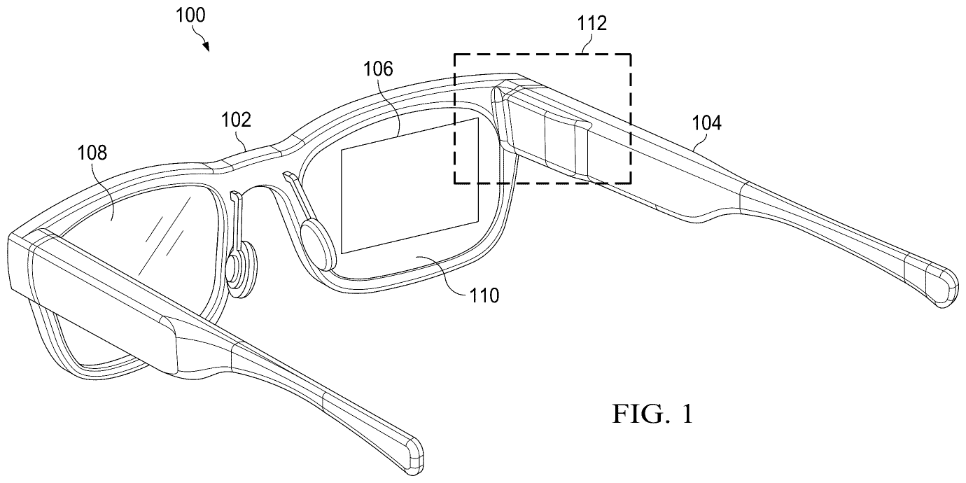

Optical display systems in HMDs sometimes include a waveguide with optical gratings, such as incoupler and outcoupler gratings, with the gratings having patterns formed using various lithographical or etching techniques. In some cases, the optical gratings are nanostructures that are formed from high-refractive index materials such as TiO₂. However, conventional methods of producing optical gratings introduce contaminants into the final waveguide product. These contaminants include undesired materials that deteriorate the performance of the waveguide by absorbing or redirecting display light intended to be directed to the user of the HMD. FIGS. 1-7 illustrate techniques to reduce or eliminate these contaminants, thereby increasing the amount of display light that is directed to the user, and thus increasing the optical performance of the waveguide.

For example, conventional waveguide production methods include a multi-step process that uses chromium (Cr) as a hardmask layer to pattern nanostructure optical gratings. In some cases, the nanostructure optical gratings are formed from a grating layer including TiO₂ that is selectively etched using the patterned Cr hardmask layer. The patterned Cr hardmask layer is eventually removed from the final waveguide product. However, during the dry etching of the TiO₂ grating layer through the patterned Cr hardmask layer and the wet etch removal of the patterned Cr hardmask layer, a residual amount of Cr remains on the surface of the TiO₂ grating layer or diffuses up to about 50-60 nm along the TiOx grain boundary. In some aspects, the TiO₂ grating layer is particularly susceptible to Cr diffusion at the TiO₂ crystal grain boundaries where the Cr contamination is difficult, if not impossible, to remove. This Cr contamination in the final waveguide product degrades the waveguide's performance since the residual Cr absorbs or redirects display light intended to be directed to the user. Accordingly, the present disclosure provides techniques to reduce or eliminate contamination of the optical gratings in a waveguide from the hardmask layer.

To illustrate, in some embodiments, a method to form optical gratings for an outcoupler or an incoupler in a waveguide includes placing a blocking layer in between a grating layer and a hardmask layer, where the grating layer is deposited on a waveguide substrate layer. For example, in some embodiments the blocking layer is a SiO₂ or SiN layer, the grating layer is a high-refractive index material such as TiO₂, and the hardmask layer is an etch-resistant layer such as Cr. In some aspects, the blocking layer is less susceptible to material transport from the hardmask layer than the grating layer. During the production process, a dry etch step patterns the Cr hardmask layer. Subsequently, the SiO₂ blocking layer and the TiO₂ grating layer are etched through to form a grating pattern in the TiO₂ grating layer, and the Cr hardmask layer is removed via wet etch removal. The SiO₂ blocking layer prevents the diffusion of Cr from the Cr hardmask layer into the TiO₂ grating layer during these processes, thus reducing or eliminating the amount of Cr contamination in the waveguide. Based on the desired optical characteristics of the waveguide, the blocking layer can be removed, or it can remain in the final waveguide product.

FIGS. 1-7 illustrate techniques to reduce or eliminate the presence of undesired contaminants, such as Cr, in a waveguide. By eliminating these contaminants, the waveguide's optical performance is increased. However, it will be appreciated that the apparatuses and techniques of the present disclosure are not limited to implementation in this particular display system or method, but instead may be implemented in any of a variety of display systems using the guidelines provided herein.

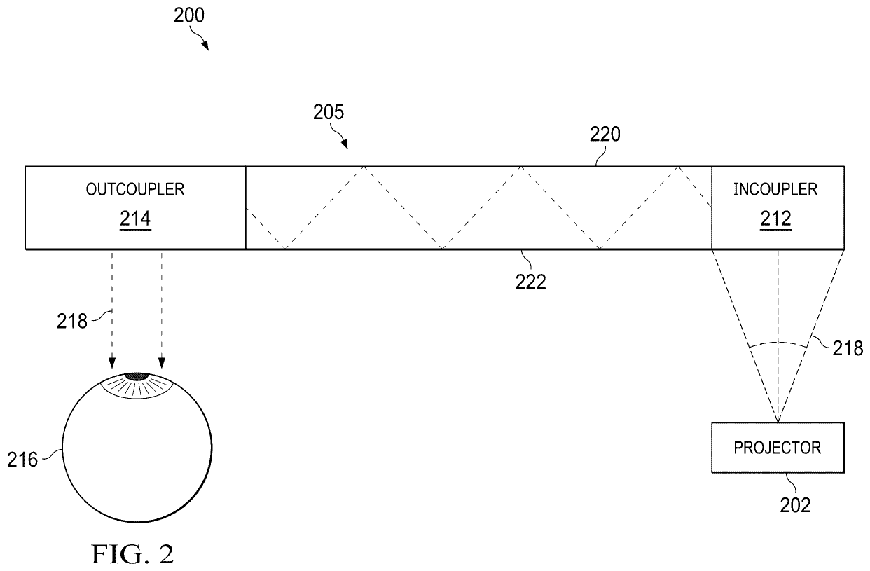

FIG. 1 illustrates an example head-mounted display (HMD) system 100 in accordance with some embodiments having support structure 102 that includes an arm 104, which houses a micro-display projection system configured to project images toward the eye of a user, such that the user perceives the projected images as being displayed in a field of view (FOV) area 106 of a display at one or both of lens elements 108, 110. In the depicted embodiment, the display system 100 includes a support structure 102, which is configured to be worn on the head of a user and has a general shape and appearance (i.e., “form factor”) of an eyeglasses frame. The support structure 102 contains or otherwise includes various components to facilitate the projection of such images toward the eye of the user, such as a projector and a waveguide (shown in FIG. 2). In some embodiments, the support structure 102 further includes various sensors, such as one or more front-facing cameras, rear-facing cameras, other light sensors, motion sensors, accelerometers, and the like. The support structure 102 further can include one or more radio frequency (RF) interfaces or other wireless interfaces, such as a Bluetooth™ interface, a WiFi interface, and the like. Further, in some embodiments, the support structure 102 includes one or more batteries or other portable power sources for supplying power to the electrical components of the HMD 100. In some embodiments, some or all of these components of the HMD 100 are fully or partially contained within an inner volume of support structure 102, such as within the arm 104 in region 112 of the support structure 102. It should be noted that while an example form factor is depicted, it will be appreciated that in other embodiments the HMD 100 may have a different shape and appearance from the eyeglasses frame depicted in FIG. 1.

One or both of the lens elements 108, 110 are used by the HMD 100 to provide an augmented reality (AR) or mixed reality (MR) display in which rendered graphical content can be superimposed over or otherwise provided in conjunction with a real-world view as perceived by the user through the lens elements 108, 110. For example, light used to form a perceptible image or series of images may be projected by the micro-display of the HMD 100 onto the eye of the user via a series of optical elements, such as a waveguide formed at least partially in the corresponding lens element, one or more scan mirrors, and one or more optical relays, and/or one or more prisms. One or both of the lens elements 108, 110 thus include at least a portion of a waveguide that routes display light received by an incoupler of the waveguide to an outcoupler of the waveguide, which outputs the display light toward an eye of a user of the HMD 100. The display light is modulated and projected onto the eye of the user such that the user perceives the display light as an image in FOV area 106. In addition, each of the lens elements 108, 110 is sufficiently transparent to allow a user to see through the lens elements to provide a field of view of the user's real-world environment such that the image appears superimposed over at least a portion of the real-world environment.

In some embodiments, the projector is a digital light processing-based projector, a scanning laser projector, or any combination of a modulative light source such as a laser or one or more light-emitting diodes (LEDs) or organic light-emitting diodes (OLEDs). In some embodiments, the projector includes multiple laser diodes (e.g., a red laser diode, a green laser diode, and/or a blue laser diode) and at least one scan mirror (e.g., two one-dimensional scan mirrors, which may be micro-electromechanical system (MEMS)-based or piezo-based). The projector is communicatively coupled to the controller (not shown) and a non-transitory processor-readable storage medium or memory storing processor-executable instructions and other data that, when executed by the controller, cause the controller to control the operation of the projector. In some embodiments, the controller controls a scan area size and scan area location for the projector and is communicatively coupled to a processor (not shown) that generates content to be displayed at the display system 100. The projector scans light over a variable area, designated the FOV area 106, of the display system 100. The scan area size corresponds to the size of the FOV area 106, and the scan area location corresponds to a region of one of the lens elements 108, 110 at which the FOV area 106 is visible to the user. Generally, it is desirable for a display to have a wide FOV area 106 to accommodate the outcoupling of light across a wide range of angles.

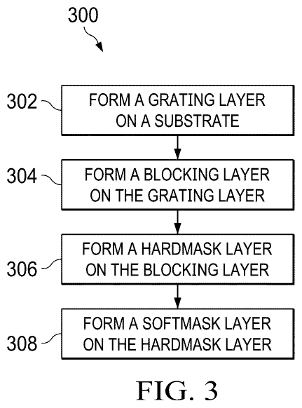

In some embodiments, the waveguide in one of or both of the lens elements 108, 110 includes an incoupler and an outcoupler with optical gratings that have little or no contamination from materials involved in the processing of the waveguide. In some embodiments, the waveguide does not include or is substantially free of any Cr contamination. In some aspects, being substantially free of any Cr contamination includes a negligible amount of Cr to minimize the Cr residual. For example, even a 0.1 nm Cr coating layer can reduce the diffractive efficiency by 10-30% for the Red/Green/Blue channel, and a 1-2 nm Cr coating layer can result in as little as zero output. In this sense, a negligible amount of Cr includes an amount that is not sufficient to noticeably impact the optical performance of the waveguide as perceived by a user of the HMD. In some embodiments, the reduction or elimination of the Cr in the waveguide is attributed to a blocking layer included in the waveguide manufacturing process as described herein, e.g., in FIGS. 3-6B.

FIG. 2 illustrates a simplified block diagram of a projection system 200 that projects images directly onto the eye 216 of a user via a waveguide 205. The projection system 200 includes a projector 202 and a waveguide 205 having an incoupler 212 and outcoupler 214, with the outcoupler 214 being optically aligned with an eye 216 of a user in the present example. For example, the outcoupler 214 substantially overlaps with the FOV area 106 shown in FIG. 1. In some embodiments, the projection system 200 is implemented in a wearable heads-up display or other display system, such as the HMD system 100 of FIG. 1.

The projector 202 includes one or more light sources configured to generate and output display light 218 (e.g., visible light such as red, blue, and green light and, in some embodiments, non-visible light such as infrared light). In some embodiments, the projector 202 is coupled to a driver or other controller (not shown), which controls the timing of emission of display light from the light sources of the projector 202 in accordance with instructions received by the controller or driver from a computer processor coupled thereto to modulate the display light 218 to be perceived as images when output to the retina of an eye 216 of a user.

For example, during operation of the projection system 200, display light 218 beams are output by the light source(s) of the projector 202 and then directed into the waveguide 205 before being directed to the eye 216 of the user. The waveguide 205 of the projection system 200 includes the incoupler 212 and the outcoupler 214. The term “waveguide,” as used herein, will be understood to mean a combiner using one or more of total internal reflection (TIR), specialized filters, or reflective surfaces, to transfer light from an incoupler (such as the incoupler 212) to an outcoupler (such as the outcoupler 214). The waveguide 205 further includes two major surfaces 220 and 222, with major surface 220 being world-side (i.e., the surface farthest from the user) and major surface 222 being eye-side (i.e., the surface closest to the user). In some embodiments, the waveguide 205 is between a world-side lens and an eye-side lens, which form lens elements 108, 110 shown in FIG. 1, for example. In some embodiments, incoupler 212 and outcoupler 214 are located, at least partially, at major surface 220. In another embodiment, incoupler 212 and outcoupler 214 are located, at least partially, at major surface 222. In further embodiments, incoupler 212 is located at one of the major surfaces, while outcoupler 214 is located at the other of the major surfaces.

In some display applications, the light is a collimated image, and the waveguide 205 transfers and replicates the collimated image to the eye. In general, the terms “incoupler” and “outcoupler” will be understood to refer to any type of optical grating structure, including, but not limited to, diffraction gratings, holograms, holographic optical elements (e.g., optical elements using one or more holograms), volume diffraction gratings, volume holograms, surface relief diffraction gratings, or surface relief holograms. In some embodiments, a given incoupler or outcoupler is configured as a transmissive grating (e.g., a transmissive diffraction grating or a transmissive holographic grating) that causes the incoupler or outcoupler to transmit light and to apply designed optical function(s) to the light during the transmission. In some embodiments, a given incoupler or outcoupler is a reflective grating (e.g., a reflective diffraction grating or a reflective holographic grating) that causes the incoupler or outcoupler to reflect light and to apply designed optical function(s) to the light during the reflection. In the present example, the light 218 received at the incoupler 212 is relayed to the outcoupler 214 via the waveguide 205 using TIR. A portion of the light 218 is then output to the eye 216 of a user via the outcoupler 214. As described above, in some embodiments the waveguide 205 is implemented in an optical combiner as part of an eyeglass lens, such as the lens element 108, 110 (FIG. 1) of the display system having an eyeglass form factor and employing projection system 200.

Although not shown in the example of FIG. 2, in some embodiments additional optical components are included in any of the optical paths between the projector 202 and the incoupler 212, between the incoupler 212 and the outcoupler 214, or between the outcoupler 214 and the eye 216 (e.g., in order to shape the light for viewing by the eye 216 of the user). In some embodiments, a prism (not shown) is used to steer light from the projector 202 into the incoupler 212 so that light is coupled into incoupler 212 at the appropriate angle(s) to encourage propagation of the light in waveguide 205 by TIR. Also, in some embodiments, an exit pupil expander, such as a fold grating, is arranged in an intermediate stage between incoupler 212 and outcoupler 214 to receive light that is coupled into waveguide 205 by the incoupler 212, expand the light, and redirect the light towards the outcoupler 214, where the outcoupler 214 then couples the light out of waveguide 205.

In some embodiments, the incoupler 212 and/or the outcoupler 214 of the waveguide 205 have little or no contamination from materials involved in the processing of the waveguide. For example, the waveguide including the incoupler and the outcoupler has little or contamination from the hardmask layer used to pattern the optical gratings of the incoupler 212 and/or the outcoupler 214. In some embodiments, the reduction or elimination of the hardmask layer contamination in the waveguide is attributed to a blocking layer, such as SiO2 or SiN, included between the grating layer and the hardmask layer in the waveguide manufacturing process.

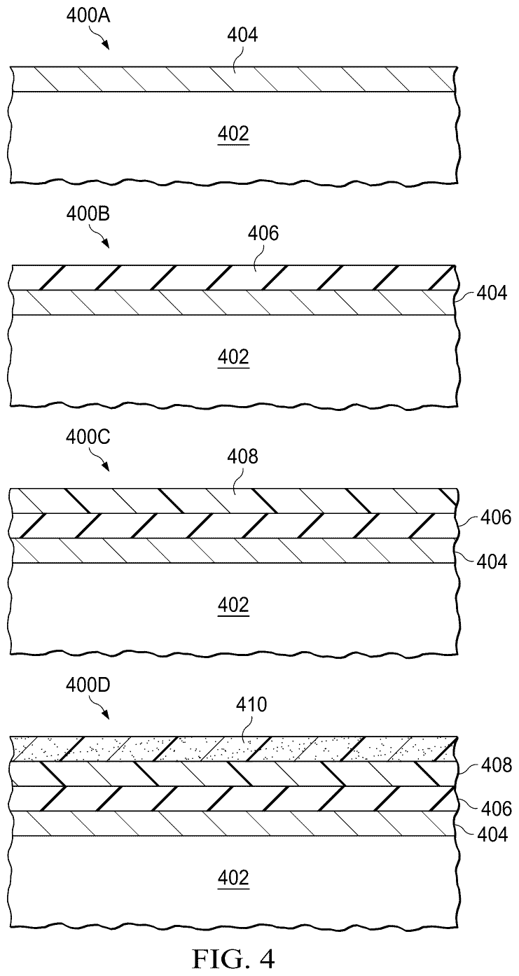

FIG. 3 shows a flowchart 300 of a method for assembling a waveguide fabrication stack to use in the manufacturing of a waveguide such as waveguide 205 in FIG. 2 in accordance with some embodiments. FIG. 4 shows diagrams 400A-400D illustrating the method shown in FIG. 3. For purposes of clarity and conciseness, FIGS. 3 and 4 are referenced together.

At 302, the method includes forming a grating layer on a substrate, such as forming grating layer 404 on substrate 402 in diagram 400A. In some embodiments, the substrate 402 is a transparent substrate such as a glass or other silica-based material, a polymer, a plastic, a transparent oxide, or any combination thereof. The substrate 402, for example, corresponds to the substrate of the waveguide 205 shown in FIG. 2. In some embodiments, the substrate 402 has a thickness from 300 nm to 800 nm (0.3 mm to 0.8 mm. In some embodiments, the grating layer 404 is formed over an entire or a majority of at least one of the major surfaces of the substrate 402 (such as major surfaces 220, 222 of waveguide 205 in FIG. 2). In some embodiments, the grating layer 404 is a high-refractive index material that is selected based on the optical characteristics of the optical gratings (e.g., the incoupler and the outcoupler) of the final waveguide product, such as waveguide 205. For example, in some embodiments the grating layer 404 is a TiO₂ layer. The grating layer 404, for example, has a thickness between 20 nm and 300 nm and, in some embodiments, is deposited on the substrate via any one of numerous film deposition methods such as chemical vapor deposition (CVD), physical vapor deposition (PVD), atomic layer deposition (ALD), spin-coating, or another similar method.

At 304, the method includes forming a blocking layer on the grating layer, such as forming blocking layer 406 on grating layer 404 in diagram 400B. In some embodiments, the blocking layer 406 is deposited on the grating layer 404 via any one of the aforementioned film deposition methods. The material for the blocking layer 406, for example, is selected based on one or more considerations, including: having similar optical characteristics (such as a refractive index) as grating layer 404, having low light absorption qualities corresponding to the display light to be incoupled into the waveguide, or having a similar etch rate chemistry as grating layer 404. For example, in some embodiments the blocking layer 406 is SiO₂ or SiN. In some embodiments, the blocking layer 406 has a thickness between 10 nm and 100 nm.

At 306, the method includes forming a hardmask layer on the blocking layer, such as forming a hardmask layer 408 on blocking layer 406 in diagram 400C. In some embodiments, the hardmask layer 408 is an etch-resistant material deposited by CVD, PVD, ALD, or another thin-film deposition technique. For example, the hardmask layer 408 is a Chromium (Cr) layer with a thickness between 10 nm and 100 nm.

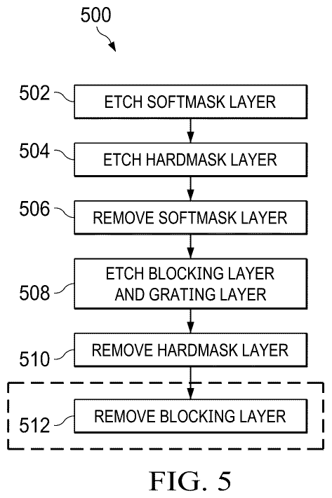

At 308, the method includes forming a softmask layer on the hardmask layer, such as forming softmask layer 410 on hardmask layer 408 in diagram 400D. In some embodiments, the softmask layer 410 is a sol-gel material that is applied via a sol-gel process involving the conversion of monomers into colloidal solution (sol-) that acts as a precursor for a network of polymers or other particles (-gel). For example, the sol-gel material is applied by a first treating the hardmask layer 408 with a solution or colloids of a polymer agent and then curing or drying it to form the softmask layer 410. In some embodiments, the softmask layer 410 has a thickness of several micrometers, e.g., between 0 and 5 micrometers. For purposes of this description, the assembly of layers illustrated in diagram 400D is referred to as a waveguide fabrication stack. FIGS. 5-7 show the formation of a waveguide with optical gratings having reduced contamination using the waveguide fabrication stack 400D as a starting block.

Accordingly, by introducing the blocking layer 406 between the grating layer 404 and the hardmask layer 408, contamination from the hardmask layer 408 on the grating layer 404 during the subsequent processing features shown in FIGS. 5 and 6-7 is reduced or eliminated.

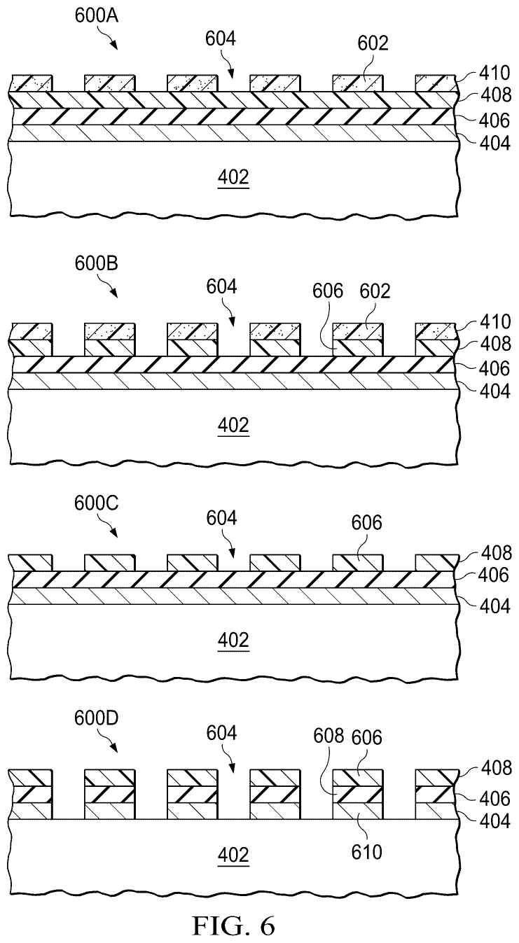

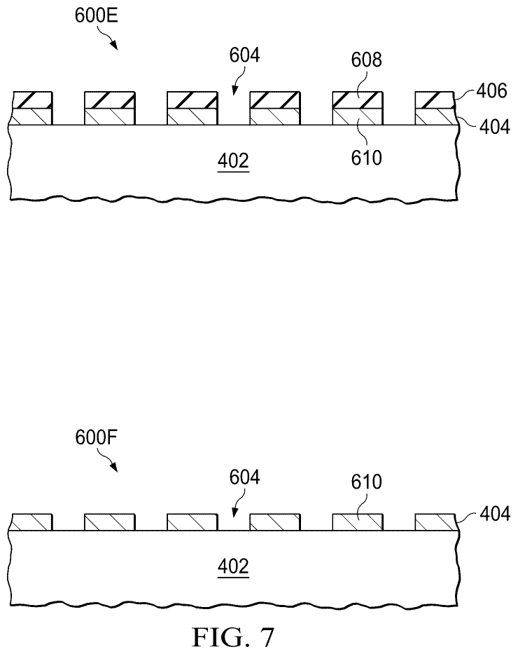

FIG. 5 shows a flowchart 500 of a method for forming a waveguide (from the waveguide fabrication stack 400D) with optical gratings having reduced contamination, such as waveguide 205, in accordance with some embodiments. FIGS. 6-7 show diagrams 600A-600F illustrating the method described in FIG. 5. For purposes of clarity and conciseness, FIGS. 5 and 6-7 are referenced together.

At 502, the method includes etching the softmask layer, such as etching of softmask layer 410 in diagram 600A of FIG. 6. For example, this etching includes nano-imprint lithography (NIL) application to form a pattern in the softmask layer 410. The pattern includes a plurality of etched away features to leave a plurality of softmask raised features 602 (one shown for clarity).

At 504, the method includes etching the hardmask layer, such as etching of hardmask layer 408 in diagram 600B of FIG. 6. In some embodiments, this etching includes a dry etch to create a pattern in the hardmask layer 408. For example, the dry etch is a reactive-ion etching. As such, a plurality of gaps 604 (one shown for clarity) are formed in the hardmask layer 408 to expose portions of the surface of the blocking layer 406 in between hardmask layer segments 606 (one shown for clarity).

At 506, the method includes removing the softmask layer, such as removing the softmask layer 410 in 600C of FIG. 6. In some embodiments, this includes washing away the remaining plurality of softmask raised features 602 in softmask layer 410 with a solution. For example, in some embodiments, the solution is a reactive solution that is selected based on the types of materials utilized in the sol-gel process. Accordingly, once the softmask layer 410 is removed, the plurality of gaps 604 exposing the blocking layer 406 in between the between hardmask layer segments 606 remains.

At 508, the method includes etching through the exposed surface of the blocking layer and the grating layer toward the substrate layer, such as etching through blocking layer 406 and grating layer 404 in diagram 600D of FIG. 6. In some embodiments, this includes dry etching through the blocking layer 406 and the grating layer 404 utilizing the same dry etch reagents. Accordingly, the gaps 604 between the plurality of hardmask layer segments 606 is extended through the blocking layer 406 and grating layer 404 down toward the substrate layer 402. In some embodiments, the gaps 604 extend all the way down to the surface of the substrate layer 402. This dry etching process forms a pattern of ridges 610 (one shown for clarity) in the grating layer 404 and a plurality of caps 608 (one shown for clarity) in the blocking layer 406 in between the pattern of ridges 610 in the grating layer 404 and the hardmask layer segments 606 in hardmask layer 408. In some embodiments, the materials selected for the blocking layer 406 and the grating layer 404 have a similar etch rate for the dry etch reagents used in the etch removal 508. For example, in some embodiments, the blocking layer 406 is made of SiO₂ of SiN and the grating layer 404 is made of TiO₂.

At 510, the method includes removing the hardmask layer, such as removing the hardmask layer segments 606 in the hardmask layer 408 in diagram 600E of FIG. 7. In some embodiments, this includes wet etch removing the hardmask layer 408. For example, if the hardmask layer 408 is made of Cr, removing the hardmask layer in 510 includes utilizing an appropriate liquid chemical or etchant solution to remove the remaining Cr in the hardmask layer segments 606 of the hardmask layer 408. Accordingly, the plurality of caps 608 in the blocking layer 406 on top of the pattern of ridges 610 in the grating layer 404 remains.

In some embodiments, the diagram shown in 600E with the plurality of caps 608 in the blocking layer 406 on top of the pattern of ridges 610 in the grating layer 404 corresponds to the final waveguide product. In other words, the plurality of caps 608 in the blocking layer 406 on top of the pattern of ridges 610 in the grating layer 404 corresponds to the optical grating structure for the incoupler 212 and/or the outcoupler 214 of waveguide 205 in FIG. 2. In some embodiments, the decision whether to leave the plurality of caps 608 in the blocking layer 406 in the waveguide is based on one or more considerations. In some embodiments, one of these considerations is an optical consideration, e.g., if the plurality of caps 608 enhances the outcoupling of light or incoupling of light at an outcoupler or incoupler, respectively. In some embodiments, another one or an alternative consideration is a contamination resistant consideration in which leaving the plurality of caps 608 increases the optical grating's resistance to contamination, albeit without a significant impact (or with a negligible impact) on optical performance.

In other embodiments, at 512, the method includes removing the blocking layer, such as removing the plurality of caps 608 in the blocking layer 406 in diagram 600F of FIG. 7. This includes wet etching or dry etching the plurality of caps 608 in the blocking layer 406 from the diagram 600E to produce the waveguide shown in diagram 600F.

In either case (i.e., whether the plurality of caps 608 from the blocking layer 406 is removed or not), the final waveguide product includes a substrate corresponding to 402 with an optical grating (i.e., an outcoupler and/or incoupler) corresponding to the structure shown in either 600E or 600F. Each of these structures (600E and 600F) include a waveguide substrate 402 with an optical grating (corresponding to pattern of ridges 610 in the grating layer 404) with little or no contamination resulting from the waveguide manufacturing process. In other words, the blocking layer 406 prevents the transfer or diffusion of materials from the hardmask layer 408 (such as Cr) into the grating layer 404 that forms the optical grating(s) in the waveguide.

In some embodiments, the techniques shown in FIGS. 3-7 are performed over two or more iterations, where each iteration separately applies the optical grating for the incoupler or for the outcoupler to a waveguide. In this manner, the materials and/or etching steps can be particularly selected and applied based on the desired structure of the incoupler grating and the desired structure of the outcoupler grating. In other embodiments, the incoupler and the outcoupler are applied to the waveguide during a single, common iteration of the techniques shown in FIGS. 3-7.

Therefore, the techniques of the present disclosure, such as those described in FIGS. 1-7, are particularly tailored to the reduction of contamination in optical gratings (e.g., diffractive and refractive optical gratings). Accordingly, the techniques described herein not only account for the final structural configuration of the optical gratings (e.g., the optical grating structure for the incoupler and the outcoupler) but also account for contaminants that degrade the optical performance of the final optical product. That is, the techniques described herein provide a waveguide with a structural configuration that includes improved optical characteristics compared with conventional waveguides. These improved optical characteristics are attributed, at least in part, to the reduced contamination of undesired materials, such as material left over from the hardmask layer, in the final waveguide product.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

1. A method of producing a waveguide with one or more optical gratings, the method comprising:
forming a blocking layer between a grating layer and a hardmask layer, the grating layer located on a surface of a substrate layer corresponding to a substrate of the waveguide;
etching the hardmask layer in a first etching step to form a plurality of hardmask layer segments with a plurality of gaps therebetween exposing a surface of the blocking layer;
etching through the exposed surface of the blocking layer toward the surface of the substrate layer in a subsequent etching step to form a plurality of caps in the blocking layer between the plurality of hardmask layer segments and a plurality of ridges in the grating layer; and
removing the plurality of hardmask layer segments, wherein the plurality of ridges in the grating layer corresponds to the one or more optical gratings.

2. The method of claim 1, further comprising removing the plurality of caps in the blocking layer to leave the plurality of ridges in the grating layer on the substrate layer.

3. The method of claim 1, wherein the blocking layer comprises SiO₂ or SiN.

4. The method of claim 3, wherein the grating layer comprises TiO₂.

5. The method of claim 4, wherein the hardmask layer comprises Cr.

6. The method of claim 1, further comprising forming a softmask layer on the hardmask layer and patterning the softmask layer to form a pattern used to etch the hardmask layer in the first etching step.

7. The method of claim 6, further comprising patterning the softmask layer via nano imprint lithography (NIL).

8. The method of claim 6, further comprising removing the softmask layer after the first etching step.

9. The method of claim 6, wherein the softmask layer comprises a sol-gel material.

10. The method of claim 1, wherein the subsequent etching step comprises using a common etching reagent to etch through the blocking layer and the grating layer.

11. The method of claim 1, wherein the subsequent etching step comprises etching through the blocking layer and the grating layer to the surface of the substrate layer.

12. The method of claim 1, wherein the one or more optical gratings correspond to at least one of an incoupler or an outcoupler.

13. The method of claim 1, wherein the plurality of ridges in the grating layer are substantially free of contamination from the hardmask layer.

14. A method of producing a waveguide with one or more optical gratings, the method comprising:
forming a blocking layer between a grating layer and a hardmask layer, the grating layer located on a surface of a substrate layer corresponding to a substrate of the waveguide;
etching the hardmask layer in a hardmask etching step to form a plurality of hardmask layer segments with a plurality of gaps therebetween exposing a surface of the blocking layer; and
etching through the exposed surface of the blocking layer toward the surface of the substrate layer in a subsequent etching step to form a plurality of caps in the blocking layer between the plurality of hardmask layer segments and a plurality of ridges in the grating layer, wherein the blocking layer reduces diffusion from the hardmask layer into the grating layer.

15. The method of claim 14, further comprising removing the plurality of hardmask layer segments via a wet etch removal to leave the plurality of caps in the blocking layer over the plurality of ridges in the grating layer on the substrate layer, wherein the plurality of ridges in the grating layer is substantially free from contaminants resulting from the hardmask layer.

16. The method of claim of claim 14, the grating layer comprising TiO₂.

17. The method of claim 16, the blocking layer comprising SiO₂ or SiN.

18. The method of claim 17, the hardmask layer comprising Cr.

19. The method of claim 14, wherein the plurality of ridges in the grating layer corresponds to the one or more optical gratings, wherein the one or more optical gratings are at least one of an incoupler or an outcoupler.

20. A waveguide comprising:
one or more optical gratings comprising a first, high-refractive index material, each of the one or more optical gratings comprising a plurality of ridges; and
a plurality of caps covering the plurality of ridges, wherein the plurality of caps comprises a second material different from the first, high-refractive index material, wherein the plurality of caps shields the plurality of ridges from contamination attributed to a hardmask layer during the fabrication of the waveguide.
